(19) United States
(12) Patent Application Publication
(10) Pub. No.: US 2026/0360233 A1
(43) Pub. Date: Nov. 12, 2026

(54) User Configurable Cloud-Based System For Monitoring Location And Status Of Field Sensors

(71) Applicant: Howe Neat, Inc., Redding, CA (US)

(72) Inventor: Daniel Howe, Redding, CA (US)

(21) Appl. No.: 19/746,832

(22) Filed: Jul. 20, 2026

Related U.S. Application Data
(63) Continuation-in-part of application No. 17/900,647, filed on Aug. 31, 2022, now Pat. No. 12,693,647.
(60) Provisional application No. 63/239,110, filed on Aug. 31, 2021.

(51) Int. Cl. G08B 5/38; G08B 25/00; H04Q 9/00

(52) U.S. Cl. CPC G08B 5/38; G08B 25/009; H04Q 9/00; H04Q 2209/886

(57) ABSTRACT

An automated monitoring status indicating node includes a body, an exteriorly arranged status indicator comprising at least one light source operable to provide different colors, patterns, and intensity, and a memory and processor operable to activate the status indicator based on the status of a field device being monitored and according to user-chosen instructions stored on the node. Related methods are disclosed.

### CROSS-REFERENCE TO RELATED APPLICATIONS

This application is a continuation in part application of application no. 17/900,647, filed Aug. 31, 2022, entitled “Automated status indicating monitoring and control node”, which claims priority to provisional application no. 63/239,110, filed Aug. 31, 2021, and entitled “Automated status indicating monitoring and control node”.

### BACKGROUND

### 1. Field of the Invention

The invention relates to nodes for monitoring the status of devices, and more particularly, to nodes for automatically visually indicating the status of devices being monitored.

### 2. Description of the Related Art

In various industrial applications, remotely-operated nodes are installed to monitor and/or control another device such as a motor, remote operated valve, or a stand-alone sensor input. Such nodes, however, pose an operational risk for industrial operators due to the complexity of remote management interacting with onsite personnel. The risk to onsite personnel includes remote start/stop of a pump while a user is nearby, or additionally the motor of a pump could be in an error state and require attention to reduce damage to property.

Presently, operators manually operate the devices and when an error exists, operators must visually inspect sensor indicators such as pressure gauges. This requires the operator to be very close, namely, within arm’s reach, of the device. This is undesirable.

Various patents discuss communicating information with an operator. For example, a computer node is described in US Patent No. 9,977,469 to Christfort, entitled “Modular computing node” for communicating with an operator. However, the ‘469 patent presents information to the operator using an LCD on the node itself which is difficult to read in a wide range of situations (such as e.g., when an operator is driving a tractor at a distance from the node). The LCD is small. This is undesirable.

Various software monitoring methods provide remote monitoring (whether on a mobile or desktop computer). However, in industrial settings such as at an agriculture pump site, a highly conspicuous onsite monitoring indicator is desired for safety and operation purposes – and one that does not require the operator to be immediately adjacent to the device.

Thus, there is still a need for visually and conspicuously presenting the status of a node and its attached inputs and outputs to an end user. There is also a need for visually presenting the status of the node device and its attached inputs and outputs to an end user onsite, and without requiring the operator to read a display of any sort.

### SUMMARY

A field-deployed monitoring system for sensing operating conditions of at least one, or many remotely connected devices on a site and providing a visible indication without requiring a display, the system comprising: a monitoring node comprising: an enclosure, and a cap coupled to the enclosure; a processor and memory disposed within the enclosure; a wireless communication module; one or more sensor interfaces configured to receive signals representing operating conditions of at least one device; and a status indicator.

In embodiments, the processor is configured to: compare the received signals to stored status indication logic including one or more conditions associated with the at least one device; activate the status indicator to provide different light patterns, intensity, or color based on a condition of the at least one device so as to provide a visible indication of the condition; and wherein the monitoring node is operable to receive and store updated status indication logic to define the light patterns, intensity, or color associated with the condition of the at least one device whereby the light patterns, intensity, or color are configurable.

In embodiments, the system further comprises an external energy source arranged on at least one of the enclosure and the status indicating light/interface.

In embodiments, the system further comprises a computing device, the computing device comprising a graphical user interface configured to configure the status indicator by mapping a sensor condition to a corresponding light indicator action.

In embodiments, the graphical interface is configured to present representations of a plurality of monitoring nodes in relation to a physical environment and to indicate a condition of each monitoring node via the representations.

In embodiments, the graphical interface is further configured to present information corresponding to operating conditions of the monitoring nodes, selectively present a subset of the information based on one or more criteria, and generate an export of the information.

In embodiments, the computing device is located on the site. In embodiments, the computing device is locally at the site. In some embodiments, the computing device is in the cloud, remote, or part of a cloud computing platform.

In embodiments, the system further comprises a computing device configured to maintain a representation of a site associated with a plurality of monitoring nodes, wherein the representation of the site is retained independent of changes to the plurality of monitoring nodes such that information corresponding to operating conditions at the site is preserved when at least one monitoring node is removed or replaced.

In embodiments, a non-transitory computer-readable medium storing instructions that, when executed by a processor of a monitoring node, cause the monitoring node to: receive signals representing operating conditions of at least one device; compare the received signals to stored status indication logic including one or more conditions associated with the at least one device, the stored status indication logic including one or more threshold values associated with operating conditions of the at least one device; and activate a status indicator supported by the monitoring node to provide different light patterns, intensity, or color based on a condition of the at least one device.

In embodiments, the instructions further cause the monitoring node to: receive and store updated status indication logic that defines the light patterns, intensity, or color associated with the condition of the at least one device whereby the light patterns, intensity, and color are configurable.

In embodiments, the instructions further cause a computing device associated with the monitoring node to provide a graphical interface configured to define a correspondence between a sensor condition and a light indicator action of the status indicator.

In embodiments, an automated monitoring node for indicating status of one or more sensors comprises: a main circuit board; an enclosure housing the main circuit board; a radio communication and central processing unit module supported by the main circuit board and operable with an antenna to provide wireless connectivity; and an exteriorly arranged status indicator, the status indicator comprising at least one light source operable to emit a plurality of different user-chosen light patterns, intensities and color.

In embodiments, the radio communication and central processing unit module is operable to: receive, from a remote server, instructions for monitoring the sensors, wherein the instructions include user-chosen status indicator actions and a mapping of sensor inputs and outputs, and conditions to corresponding user-chosen status indicator actions; store the instructions in a local storage on the node, check the local storage for updates to instructions and update the local storage according to the instructions if an update was received by the node; and check the local storage for a matching sensor input and output, and instruct the status indicator to perform a status indicator action according to the local storage; and wherein the status indicator action comprises a user-chosen light pattern, intensity, and color for each condition for each sensor. Additionally, a monitoring node may utilize statistical analysis and or built-in thresholds to analyze sensor data for error in operations, and set alert conditions which may be displayed via the status indicating apparatus.

In embodiments of the invention, an automated monitoring node includes processor and memory, an antenna, a wireless communication module, and a status indicator. In embodiments, the status indicator is programmatically operable to provide different light patterns, intensity, and color based on various sensed data.

In embodiments, the wireless communication node is multi-functional and operable to communicate using different types of wireless platforms such as, for example, Wi-Fi, Bluetooth, Cellular, Satellite, and/or RF. In embodiments, sensor data may be communicated via any of the aforementioned wireless communication methods to either a cloud-based application server, or an on-premise server, or to any node connected to the same network and or server.

In embodiments, the node is operable to present a conspicuous visible status to users, and to be programmatically controlled in-field, using a configuration interface through mobile phone, or computer, or remotely using the cloud connected application. Users can choose any logical combinations such as error states, sensor values, time, or synchronization state to change light intensity, color and motion of the light status indicator.

Indeed, in order to determine a state of a field device, status indication logic and notification rules may be applied to a wide variety of conditions and inputs including, without limitation, physical sensors, virtual sensors, calculated values, historical information, external data sources, statistical analyses, predictive models, artificial intelligence models, user-defined criteria, schedules, and combinations thereof. Additionally, it is to be understood that the types of notification states may vary widely and may include, without limitation, operational conditions, alarms, recommendations, maintenance conditions, calculated values, derived values, communication status, or other computed conditions.

In embodiments, the node is configured via the configuration methods described herein, whereby the logic is programmatically derived for the status indicator. Many logic combinations can be used and corresponding light color, intensity and motion can be controlled as a method of visual indication.

In embodiments, when the node is powered up, it checks internal storage of the device, for pre-programmed status indication logic to retrieve the instructions/arrays of stored logic. In a preferred embodiment, for example, an array 1 contains the logic whereby if a sensor is below the value threshold, the light color will be red, bright intensity, flashing in a circular pattern rotating about the body of the node.

In embodiments, when the node has completed normal setup and is operating, the status of the inputs and outputs are periodically compared against the array to determine if any condition matches. If a condition is matched, the corresponding action will be activated, and a message generated to display the corresponding message in a cloud connected application. Additionally, the monitoring node may use statistical analysis to evaluate a combination of conditions and change the alert state according to pre-defined settings.

In embodiments, a method includes remotely updating the node status indication logic.

In embodiments, a cloud connection can serve to remotely monitor and control the device. However, the node is also adapted to be operable as a stand-alone device and independent of a cloud connection, WAN, LAN, or a mesh network.

In embodiments, the node is operable to allow a user to re-program the operation of the status indicator using either a directly connected computer using the programming port, remote wireless interface, or the cloud connected application from a mobile device or desktop application. A user can update the logic using either a command line terminal, or web page.

In embodiments, the node is operable to be used without the provided enclosure, where it is a standalone method for visual indication, such as when installed inside another client-provided or custom enclosure.

In embodiments, the node is operable to provide feedback specifically to the status of a sensor, or a combination of sensors and their corresponding values. Such that the irrigation status may be sensed through irrigation flow, and pump status, for example. Additionally, other sensors such as temperature and humidity could be used to alert a user of impending frost which could damage a crop, or a pressure sensor indicating over pressure conditions of a pump, or a power meter indicating status of a pump, and in some remote locations, a user interface such as a cell phone is impractical for checking the status, the subject node provides the visual alert immediately in the field. Additionally, this visual alert is matched in the cloud or on-premise software consisting of a map, a widget, or text indicating the current status.

In embodiments, an automated monitoring status indicator node includes the components and features as described herein.

An automated monitoring status indicator assembly includes the components and features as described herein.

A method for indicating status of a monitored device includes the steps as described cloud-based herein.

A computer readable set of instructions, stored on a non-transient storage, for indicating status of a monitored device is operable to perform the steps as described herein.

The description, objects and advantages of the present invention will become apparent from the detailed description to follow, together with the accompanying drawings.

### BRIEF DESCRIPTION OF THE DRAWINGS

FIG. 1 depicts a network including a plurality of nodes in accordance with an embodiment of the invention.

FIGS. 2-5 are perspective, side, top and bottom views, respectively, of a node in accordance with an embodiment of the invention.

FIG. 6 is a cross sectional view of the node shown in FIG. 3 taken along line 6-6.

FIGS. 7-8 are top and bottom perspective views, respectively, of a status indicator assembly in accordance with an embodiment of the invention.

FIG. 9 is a flow diagram of a method in accordance with embodiments of the invention.

FIG. 10 depicts a block diagram of a node in accordance with an embodiment of the invention.

FIGS. 11-12 are screen shots of a GUI in accordance with an embodiment of the invention.

FIG. 13 is a top front perspective view of a status indicator node in accordance with an embodiment of the invention.

FIG. 14 is a top front perspective view of a status indicator node in accordance with an embodiment of the invention.

FIG. 15 is a front view of the status indicator node shown in FIG. 14.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. For example, although various monitoring nodes are shown and described herein and represent various implementations, the invention is not intended to be limited to any particular enclosure, processor, communication technology, or hardware architecture except where so limited in any of the appended claims.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). US Patent No. 9,977,469, filed March 2, 2016, and entitled “Modular computing node” is incorporated herein by reference in its entirety for all purposes.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as an antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### OVERVIEW MONITORING NODE NETWORK

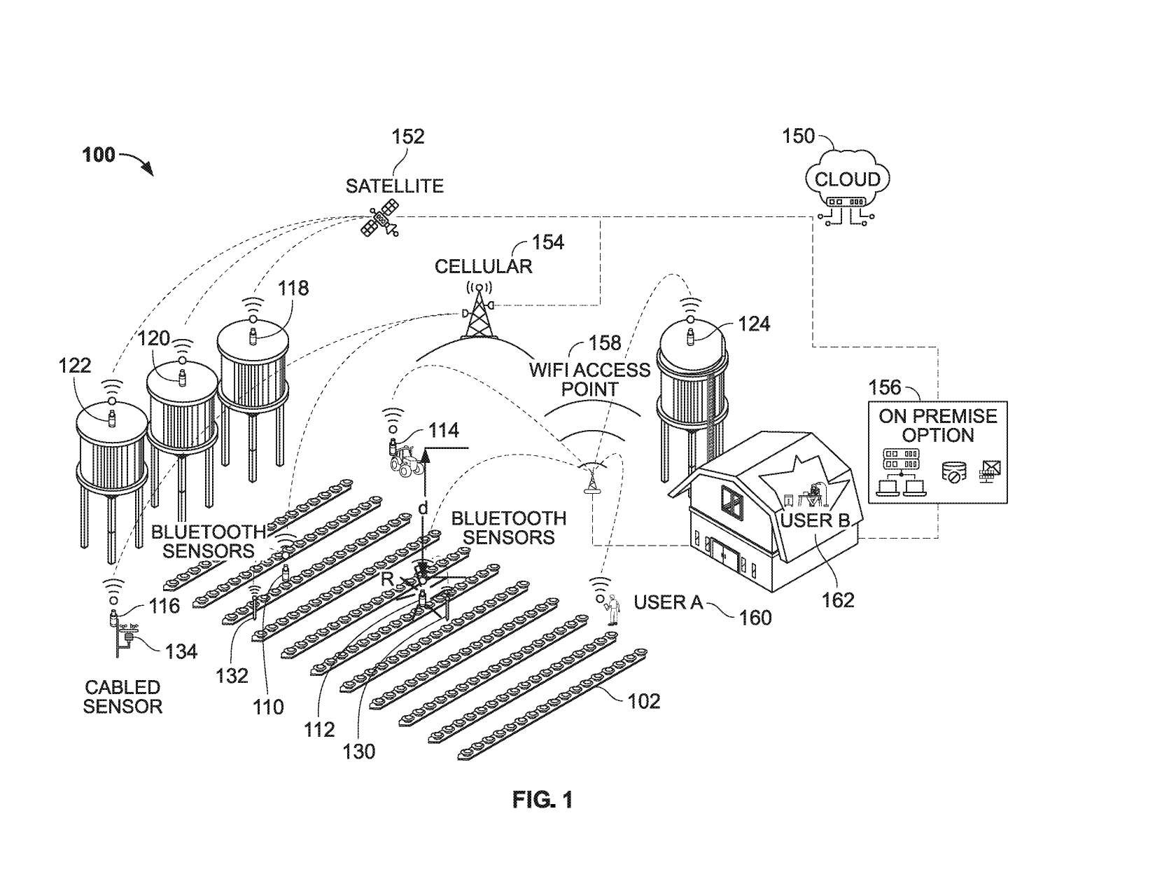

FIG. 1 depicts an example of an automated monitoring node (AMN) network 100 in accordance with an embodiment of the invention. In the example shown in FIG. 1, the AMN network 100 is directed to agricultural or industrial locations, and includes a plurality of nodes 110, 112, 114, 116, 118, 120, 122, and 124. Though 8 nodes are shown in FIG. 1, it is to be understood that the number of nodes may vary. In embodiments, a network may comprise solely one node. More often, however, a plurality of nodes may be arranged in a setting. Exemplary number of nodes range from 5-25, and more often 5-10. However, the number may be adjusted based on the size of the areas and number of equipment being monitored.

Nodes 110, 112 are shown associated with Bluetooth-compatible sensors 130,132 for detecting soil moisture.

Node 114 is shown arranged on a tractor. The node 114 is operable to receive sensor data from the tractor. The data may include, without limitation, speed, fuel, GPS location, etc.

Node 116 is shown hard wired or cabled to a weather station with temperature, humidity, wind speed and direction 134. Both the sensor 134 and node 116 are mounted on a stake, off the ground.

A plurality of nodes 118, 120, 122, 124 are shown mounted to the top of water towers. Each of these nodes can be in communication with a water level sensor for detecting water level.

Additionally, the automated monitoring nodes can be employed with a wide range of types of devices such as, for example, a controller that operates a water valve, a sensor that measures water level or humidity, a sensor that detects soil moisture levels, or at a flow meter connected to an irrigation pipe. In embodiments, a monitoring node monitors a field device as described herein.

In embodiments, the nodes are coupled to a remote server or cloud-based server system 150, discussed further herein. As shown in FIG. 1, a variety of communication technologies are available to link the nodes to the cloud including without limitation satellite 152, cellular 154, and on-premise internet 156. In the network shown in FIG. 1, the water tower nodes 118, 120, 122 are shown communicating via satellite 152 to cloud 150. Nodes 110, 116 are shown communicating with cloud via cellular tower 154. Nodes 112, 114, and 124 are shown associated with the local Wi-Fi access point 158 to the on-premises internet or intranet 156. Examples of on-premises options include an ethernet cable network.

Additionally, and although not specifically illustrated in FIG. 1, the various nodes may communicate with one another via a mesh network. However, in some embodiments, a node can communicate indirectly with an adjacent node via a cloud 150 and/or Wi-Fi access point 158. Communications may include direct, indirect, synchronous, asynchronous, delayed, routed, and multi-hop communications.

FIG. 1 also shows users 160, 162 accessing the nodes via a client device, such as a desktop computer, a smartphone, a smart watch, in vehicle infotainment system, a tablet computer, etc. As discussed further herein, the users can utilize an App on a portable computing device or web-based application hosted on a remote server to communicate with the nodes.

In the embodiment shown in FIG. 1, node 112 is illuminated (R) to alert operators of the status of the device 130 being monitored. Consequently, in embodiments, the local personnel or operator, for example a tractor operator, is able to immediately observe the status of sensor 130 via an illuminated status indicator (R) on the node 112. In embodiments, the light pattern, intensity, and color of the light is programmed according to a condition of the sensor, described herein. Advantageously, the operator can obtain information about the status of sensors, valves, and other devices being monitored by the nodes from a distance (d) well beyond arms reach of the node, and without having to read a display of a portable computing device. As described herein, the subject node illumination is a great advantage over reading a small display on the node itself or having to read a message on a portable computing device.

### Automated Monitoring Node (AMN)

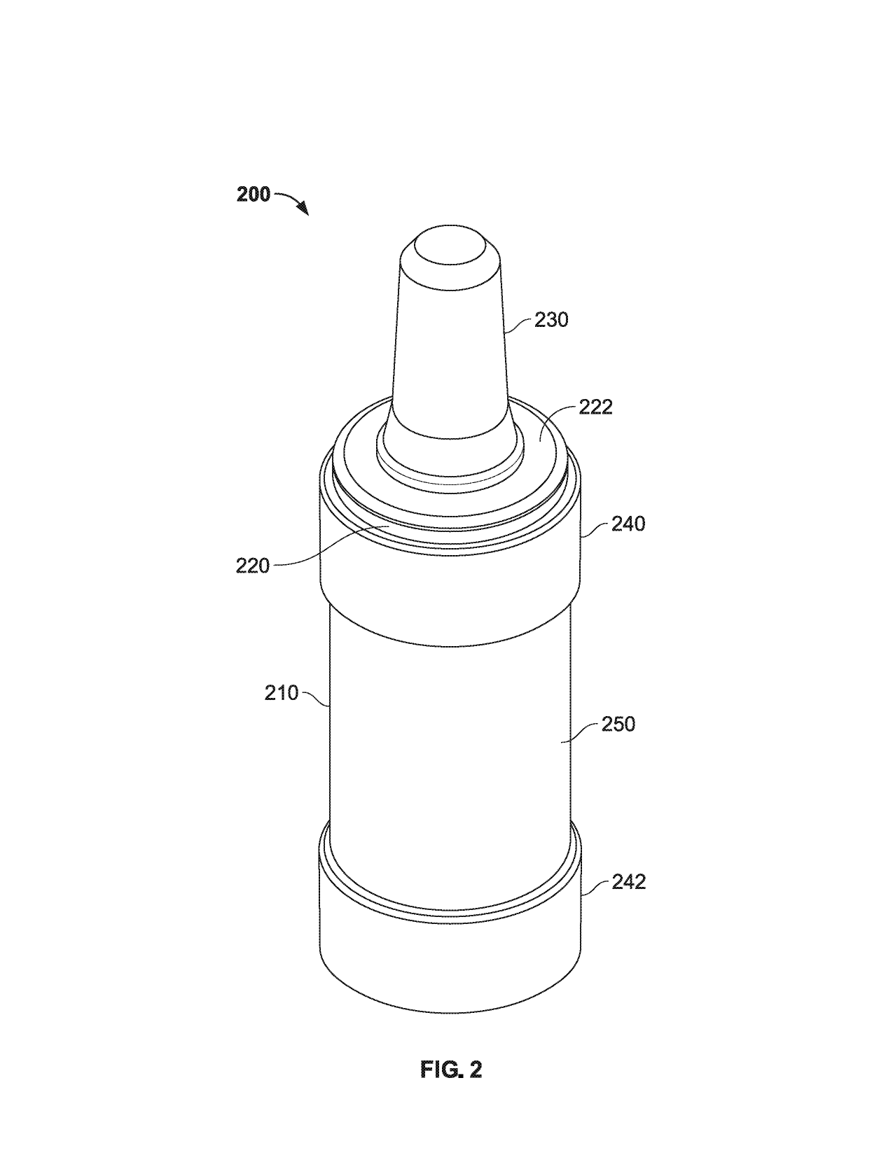

FIGS. 2-5 show a perspective, side, and top view, respectively, of an automated monitoring node 200 in accordance with an embodiment of the invention. The node 200 is shown including a tubular enclosure 210, status indicator 220, plate 222, antenna 230 and sleeves 240, 242. As discussed herein, the node is operable to be programmed to activate the light in a wide variety of patterns, colors, and intensities. As discussed herein, the enclosure 210 holds several components such as, for example, a wireless receiver such as a wifi and Bluetooth receiver 250.

### Sleeves

The node is also shown with external sleeves 222, 242, which serve to cover joints as well as provide some degree of shock/motion absorption to protect the internal components from weather or moisture. In embodiments, the sleeves 222, 242 are rubber or a polymer or another material having elasticity, vibration resistant, anti-rust and moisture resistant qualities.

With reference to FIG. 5, a bottom view of the node 200 is shown including base 262 defining a plurality of apertures 260a, b, c which may be used for a wide range of connectors or cabling such as, for example, sensors, controllers, power supply, bus, and WAN/ethernet connection.

Additionally, in some embodiments, a tortuous pathway is provided through the body of the node for sealing the node and managing the cables. In embodiments, the base or rear wall of the node includes an open tortuous (non-linear) channel adapted to receive the cable. The cable(s) are loosely laid in the open channel, and a second member or cover is secured across the cable and channel. The cover slightly compresses the cables therebetween, thus creating both a water resistance seal and strain relief to the cable. This effective cable management is also convenient to install since the operator needs only place the cable in the channel and close the node.

Alternatively, in some embodiments, the base and enclosure are holeless, thus sealing the internal electronics from the environment. Self-containing the electronics can be advantageous in oil fields or gas operations.

The node is preferably mounted or affixed to a stake, pole, fence, or another structure whether existing or added for supporting the computer node. Additionally mobile applications may include vehicle mounts, or free standing such as connected directly to a sensor inserted in the ground such as a soil moisture sensor. A wide range of hardware may be used to affix the computer node to the structure. Examples of optional fastening hardware include without limitation screws, steel ribbon, mounting brackets, zip ties. Optionally, the node may be inset within the hollow or cavity of a stake or pole member. Indeed, a wide range of techniques may be employed to mount the node. Preferably, the node is elevated so as to achieve better wireless reception and visibility to operators on site.

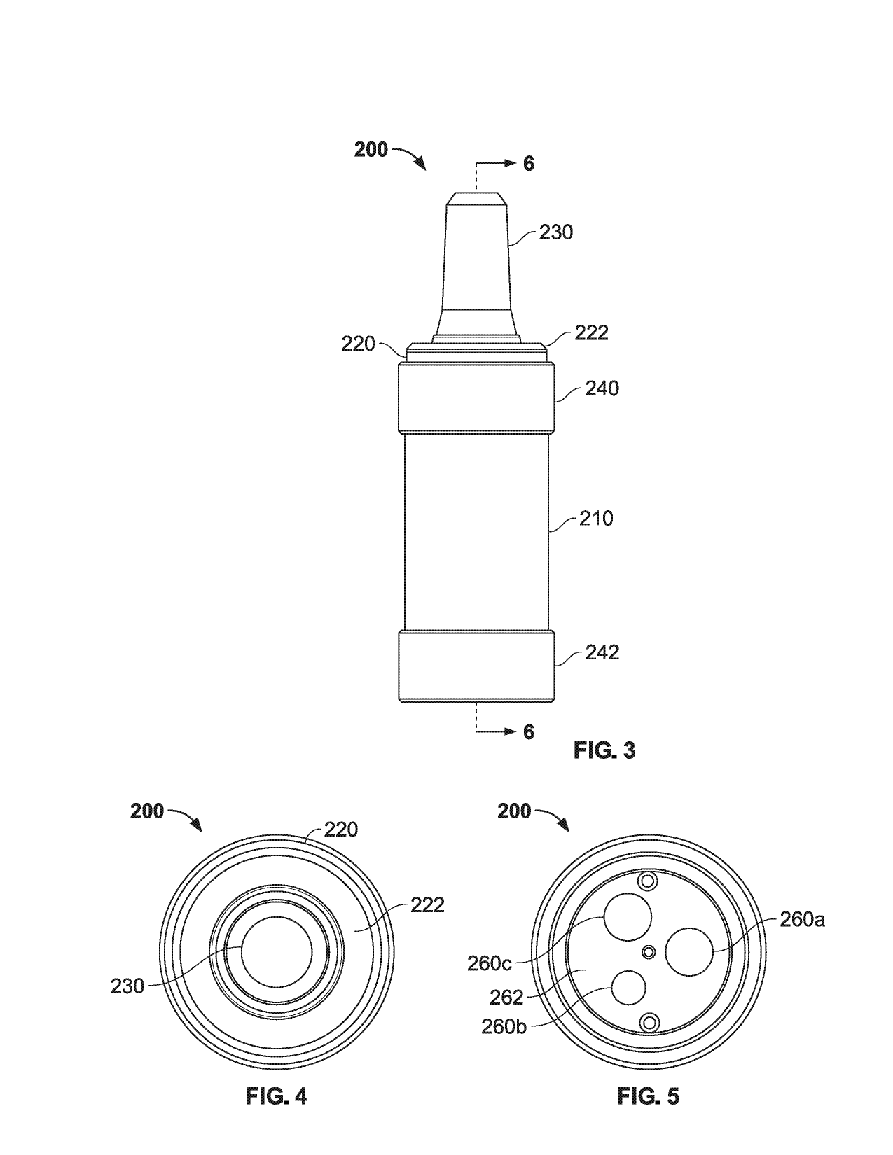

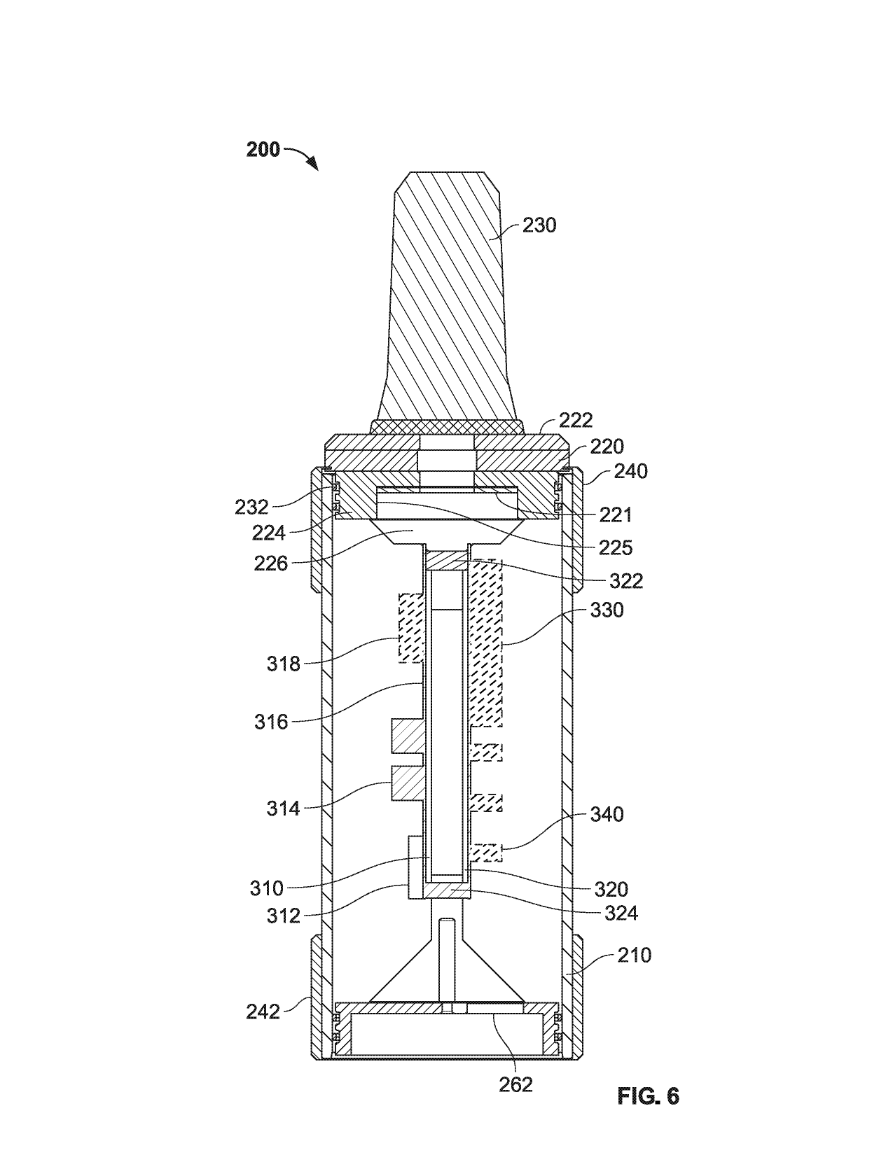

FIG. 6 shows a cross sectional view of the node shown in FIG. 3, taken along line 6-6.

### Mechanical Structure

The node 200 shown in FIG. 6 includes base 262 as described above, a rigid internal skeleton or frame 226, upper cap 224, tubular enclosure 210, and sleeves 240, 242. The caps 224, 262 are shown including O-rings or sealing members 232 that are operable to form a liquid tight seal with the tubular enclosure 210 when the tubular enclosure is joined to the caps so as to prevent moisture from reaching the internal electrical components, discussed herein.

### Electrical Components

The node 200 shown in FIG. 6 includes a main circuit board 310 which can support an integrated radio communication and CPU module 312. An example of an integrated radio communication module and CPU is the WL865E4-P Wi-Fi Module, manufactured by Telit Wireless Solutions (Durham, North Carolina). It is an integrated dual band, dual mode, combo Wi-Fi (802.11 a/b/g/n) / Bluetooth Low Energy (BLE) 5.0 module to add wireless connectivity to their products. The module is based on an integrated tri-core system-on-chip, with dedicated CPU’s for IoT application, Wi-Fi and BLE. The IoT application processor runs on ARM Cortex-M4F @128 MHz with 300KB of dedicated SRAM. Module also integrates 4MB (and in some embodiments, at least 4 MB, and in a preferred embodiment, 8, 12 or 16 MB) of internal flash with wide array of peripherals (SDIO, SPI, UART, ADC, PWM, GPIO, I2S, I2C, USB).

Another example of an integrated communication module and CPU is the Espressif ESP-32 chipset for BLE/WiFi and CPU. Its architecture is a highly integrated System-on-Chip (SoC) featuring a Tensilica Xtensa 32-bit LX6 dual-core processor, built-in 2.4 GHz Wi-Fi and Bluetooth, and rich hardware peripherals including ADCs, DACs, and touch sensors. Designed for IoT, it leverages hardware cryptographic accelerators, ultra-low power modes, and an advanced, flexible RISC architecture.

However, in other embodiments, the main board 310 can support separate components dedicated to Wi-Fi (e.g., optional radio/modem 318), Bluetooth, memory and processing that can execute instructions stored in the memory. Non-limiting examples of memory are solid-state drive (SSD), a flash program memory, a random-access memory (RAM), and/or any other volatile or non-volatile memory. Non-limiting examples of processors include digital electronic devices such as one or more field programmable gate arrays (FPGAs) that are programmed to perform the methods describes herein or may include one or more general purpose hardware processors (e.g., CPU) programmed to perform the methods described herein pursuant to program instructions in firmware, memory, other storage, or a combination. Such processors may also combine custom hard-wired logic, ASICs, or FPGAs with custom programming to accomplish the techniques. An example of a suitable processing device is model PIC24FJ1024GB610, manufactured by Microchip Technology Inc. (Chandler, AZ).

The node 200 preferably includes at least one antenna 230 that enables wireless communications with other devices. Preferably, the node has an external antenna 230 extending from the top of the enclosure that enables cellular, mesh, or other wireless communication. In embodiments, the antenna is installed at other locations about the enclosure, and in some embodiments, the antenna is arranged wholly internally. Additionally, or alternatively, node can include at least one antenna enabling the node to operate as a radio node that communicates with other connected nodes or connected mobile devices such as a user’s phone or tablet and or computer. If a node includes multiple antennas, a particular antenna can be designated as providing a primary mode of communication, and a different antenna can be designated as providing a secondary mode of communication. For example, a cellular communications antenna can provide a primary mode of communication, and a mesh networking radio antenna can be used as backup. Node can also include at least one modem, such as a cellular modem.

The node 200 shown in FIG. 6 also includes a touch sensor 316 to allow a user to directly communicate with the node. The sensor is comprised of a physical pad and or pin on the printed circuit board, which can be connected to any part of the enclosure. The touch sensor, can be used to detect the intervention of a user, to either confirm a notification or to change the state of any connected device or equipment and or machine such as a pump. As a user may not have any mobile device or way of interacting with a node, the touch sensor provides a method to allow a user to interact with nodes and is typically done by touching the device such as with a user’s hand. An example usage of the touch sensor is to acknowledge a frost alert or failed pump and to thereby stop the pump and change the pattern of the status light, for example from flashing red to solid red illumination.

The main board 310 is also shown supporting a plurality of sensor connectors. As described herein, a wide variety of sensors may be connected to the node 200 for monitoring.

### Power Supply

In embodiments, external power is supplied to the node 200 via a port in the base cap 262. The port may be configured variously to receive a power cable or connector or may be configured as a USB port and connected to the main PCB 310.

The node 200 shown in FIG. 6 also includes a second or expansion PCB 320. The expansion PCB is connected to the main PCB via interconnects 322, 324, all of which are affixed to frame 226.

The expansion PCB 320 serves to allow some degree of customization to the node and/or to add additional optional electrical components. For example, if desired, the expansion PCB can support additional sensors and control connectors 340.

The expansion PCB can also support a rechargeable battery and charge controller 330. The node may also support primary non-rechargeable battery when rechargeable battery is depleted. Examples of batteries include NCR18650, manufactured by Panasonic (Osaka, Japan), a non-rechargeable battery may include C or D cell batteries commonly available. Additionally, in embodiments, node 200 and battery can be powered and charged, respectively, by an external solar energy source.

Optionally, in embodiments, a display (not shown) may be incorporated into, or externally attached to the node (e.g., on one of the PCBs 310, 320), and the whole enclosure 210 can be made of a transparent material, and include a transparent window for the display.

FIG. 6 also shows an optional configuration of the status illumination indicator 220 sandwiched between antenna support plate 222, and upper cap 224. A dedicated status indicator PCB 221 for controlling the status illumination indicator is arranged in a recess 225 in the upper cap.

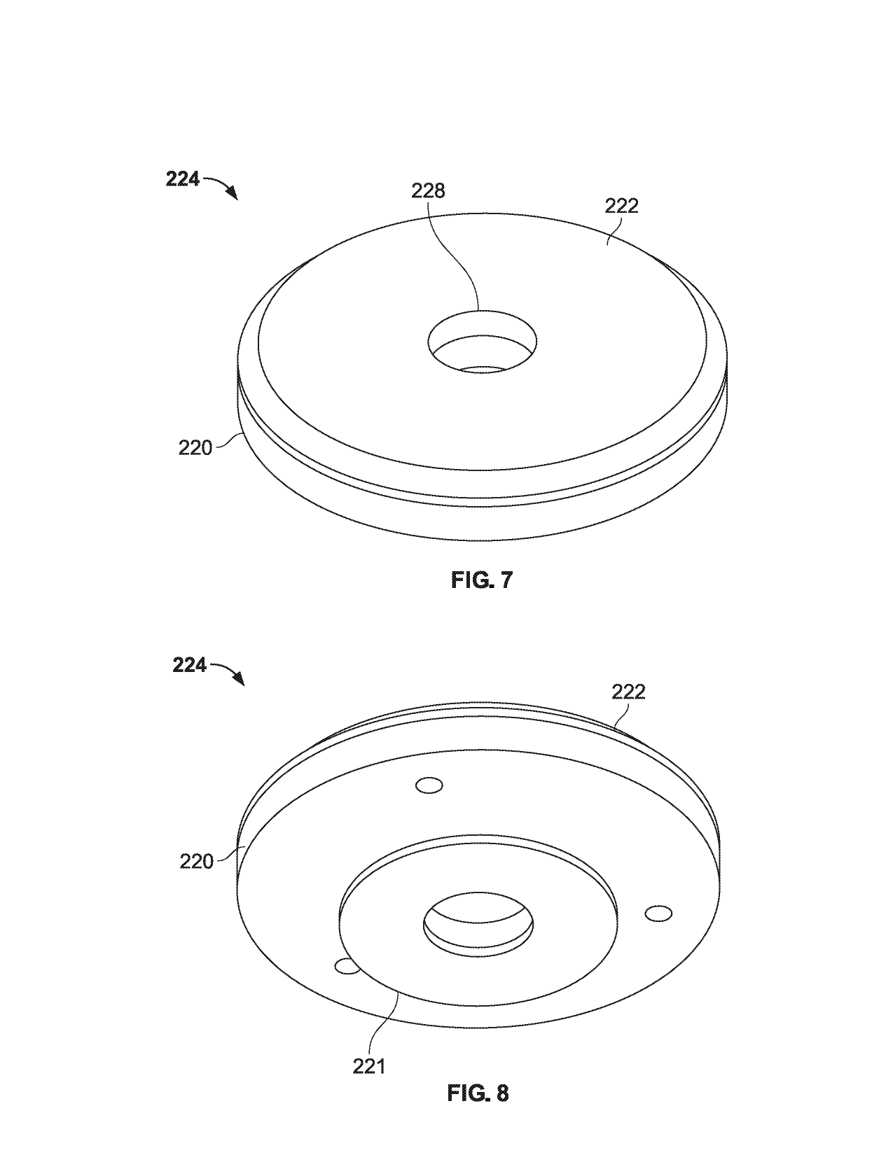

With reference to FIGS. 7-8, an enlarged top perspective view and bottom perspective view of a status indicator assembly 224 is shown in accordance with an embodiment of the invention. The status indicator assembly is shown comprising a disk-shaped illuminator or light 220, status indicator circuit 221, and an optional antenna platform or plate 222. Each of the plate, circuit, and light are shown with an aperture. However, for embodiments in which the antenna is not mounted on the top of the node, the status indicator assembly need not have a through hole.

The illuminator or light 220, as discussed herein, is operable to transmit light in the visible wavelength range, and in a wide range of predetermined patterns, intensities, and colors. An example of a suitable light with dedicated circuit is model WS2812, manufactured by Worldsemi (GuangDong, China). In embodiments, the light 220 is a stand-alone addressable LED, with programmable color, and intensity. Together with many of these LEDs an array of LEDs can be attached together to the same bus and power source, and be independently controlled.

The plate, when present, may comprise a rigid material to support the antenna. Exemplary materials for the plate are aluminum and plastic.

### Status Indicator

In embodiments, the status indicator may comprise any device or mechanism capable of conveying a notification state to a user or another computing system. The status indicator may comprise one or more light-emitting diodes (LEDs), LED arrays, LED rings, illuminated symbols, light bars, segmented indicators, liquid crystal displays (LCDs), organic light-emitting diode (OLED) displays, electronic paper displays, electroluminescent panels, illuminated buttons, projection systems, light pipes, rotating beacons, audible alarms, horns, speakers, vibration devices, haptic feedback devices, mechanical indicators, or combinations thereof.

The status indicator may communicate information through color, brightness, intensity, flash rate, duty cycle, animation, sequence, movement, symbols, text, graphics, sound, vibration, mechanical motion, projected images, or combinations thereof. Different notification states may be represented using one or more of these characteristics.

In certain embodiments, the status indicator is integrated into a monitoring node. In other embodiments, the status indicator is physically separate from the monitoring node and communicates through wired or wireless communications. Accordingly, the status indicator is not limited to any particular hardware implementation, physical location, or communication technology.

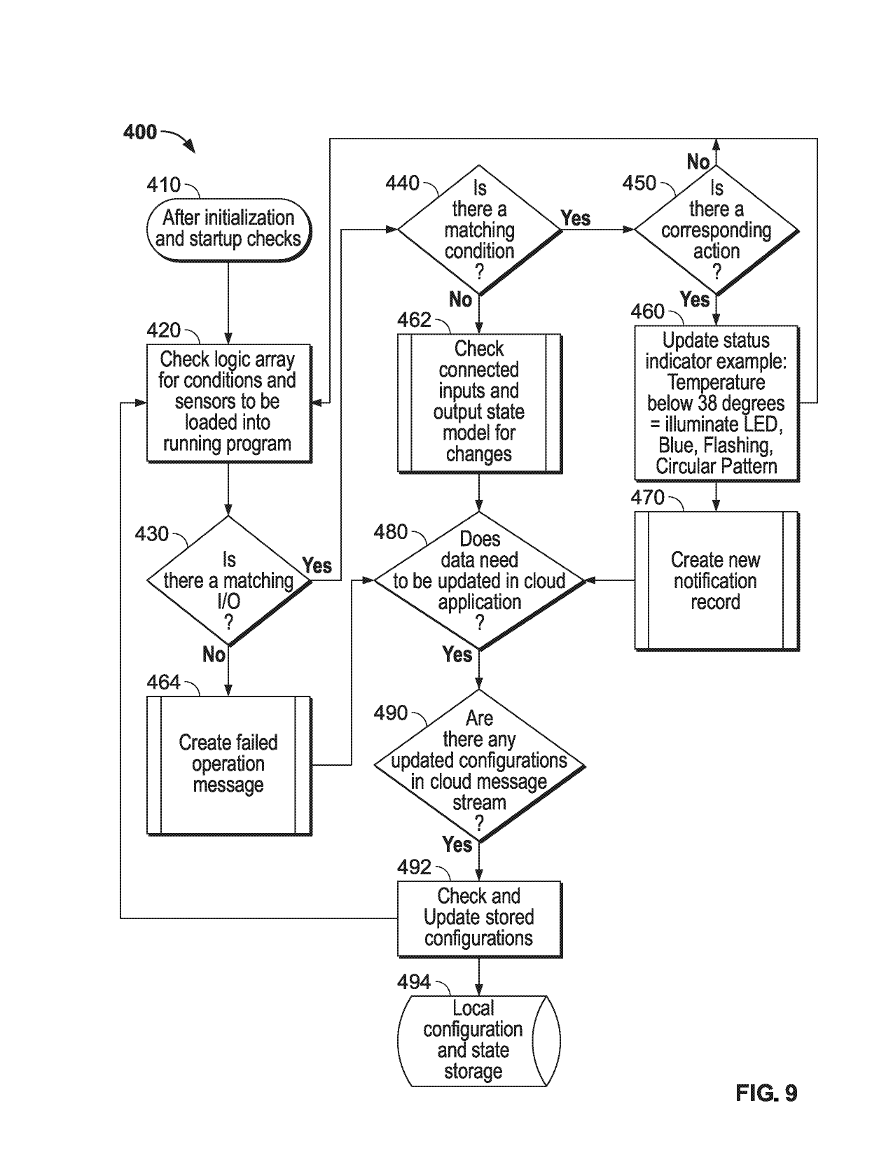

FIG. 9 is a flowchart of a method 400 indicating the status of a device (e.g., sensor or controller) being monitored by an automated monitoring node in accordance with an embodiment of the invention.

Step 410 states to perform initialization and startup checks. This step identifies if whether there are any stored errors on the node, and can create a corresponding notification record of same.

Step 420 states to check for conditions and sensors. Particularly, and with reference to step 430, the method checks for matching input/outputs. For example, is an anticipated temperature, humidity or soil moisture sensor input present. If not, the method proceeds to step 464 and generates a failed operation message. In embodiments, a failed operation message can be implemented, and when a failed sensor is detected, the notification is shown by the status light indicator flashing on and then off, specifically for example from high-intensity of approximately 7 lumens to 0 lumens, or off.

If the input/output matches, the method proceeds to step 440. Step 440 states to query for a matching condition. For example, is the temperature detecting a temperature below 38 degrees Fahrenheit. If not, the method proceeds to step 462, and the node checks for state model changes to the inputs and outputs (e.g., the temperature sensor is detecting a temperature out of realistic range, is uncalibrated properly, is detecting intermittently/inconsistently, or its reading is more or less than 5 degrees than the previous readings).

If a condition matches, the method proceeds to step 450 to determine whether there is a corresponding action. For example, and with reference to step 460, if the temperature reading is below 38 degrees Fahrenheit, the status indicator is luminated to show a blue flashing light in a circular pattern.

Step 470 creates a new notification record of the status indicator action.

Step 480 queries whether the data should be updated to the cloud application, described herein. For example, if the temperature has changed more than a threshold amount, then the data is sent to the cloud.

Step 490 states to query whether there are any updated configurations in the cloud stream. For example, an operator may determine to program the status indicator to illuminate with green light instead of blue when the temperature is below 38 degrees F. The new configuration is updated in step 492.

Step 494 states to update local state storage with the updated configuration.

Without intending to being bound to theory, one meaningful advantage of the methods and systems described herein is to allow operators of equipment see the status of nodes from a relatively long distance (d) from the node. For example, with reference to FIG. 1, the tractor operator can see the status of a monitored device 130 as she is driving a tractor at distance (d) from the node 112. Distance (d) can be 0 to 300 ft, and typically from 5 to 50 ft.

The color, intensity, and pattern of the light indicator is programmed to indicate the status of the sensor(s) being monitored. Embodiments described herein reduce or eliminate the need to be within an arm’s distance to read or understand a display describing the status of the device being monitored.

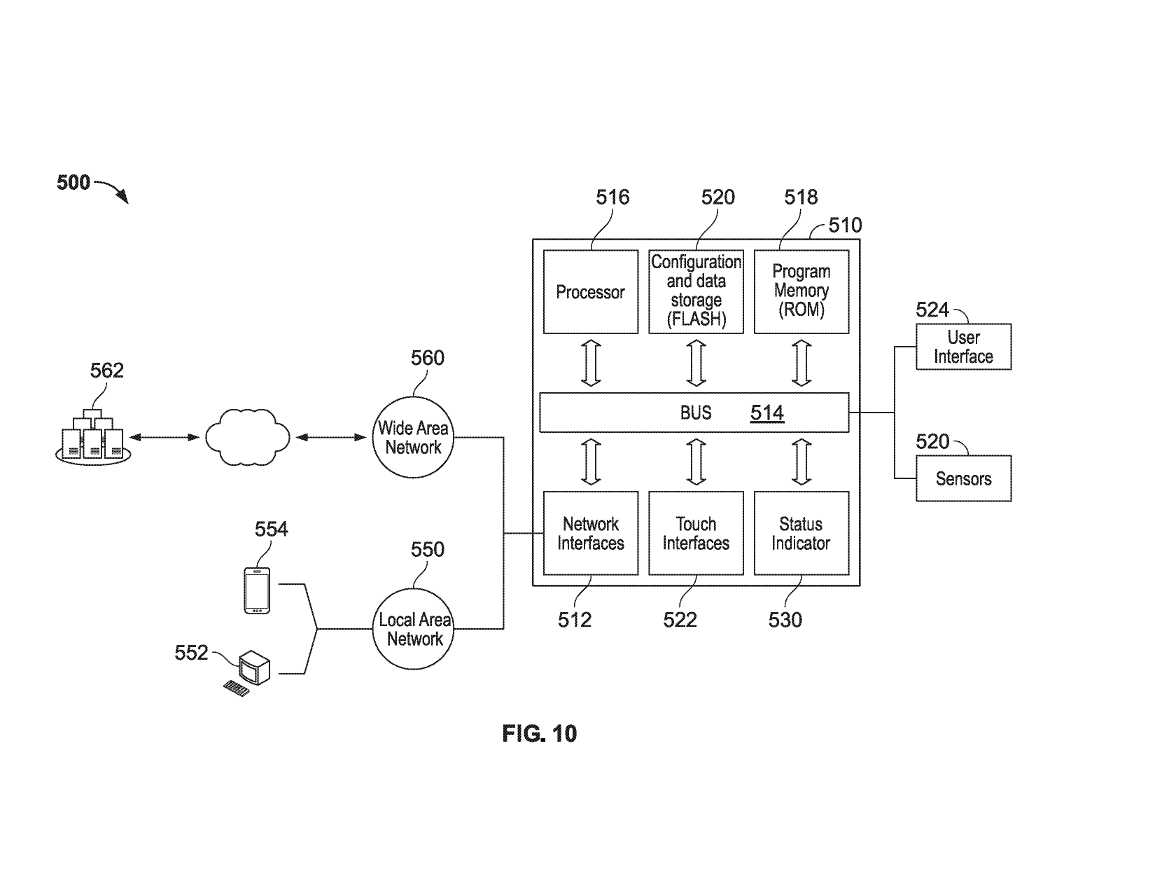

FIG. 10 depicts a block diagram of a status indicator node system 500 in accordance with an embodiment of the invention.

The system 500 is shown having a status indicating node 510 coupled to sensors 520. Examples of sensors include, without limitation, temperature sensors, humidity sensors, light sensors, etc. Optionally, the node 510 may be coupled to a controller such as a controller of a water valve for a water irrigation source. The number and types of sensors and controllers being monitored by the node may vary widely. Preferably, the devices being monitored are coupled to the node via Bluetooth however the invention is not so limited except where recited in any appended claims.

System 500 shown in FIG. 10 also includes a local area network (LAN) 550 and a wide area network (WAN) 560. The LAN and WAN can be connected to the node 510 via network interface 512. As described herein, examples of network interfaces include, without limitation, Wi-fi receivers, ethernet or WAN ports, cellular, satellite, or radio modems, etc.

The local area network 550 is shown having a computer 552 and smart phone 554. The phone and computer can be used to communicate with the node 510, and cloud servers 562. Examples of types of communication include receiving data, providing instructions, turning on and off any attached equipment such as pumps, and programming the node. In embodiments, a smart phone or tablet is operable (e.g., via a downloaded App) to communicate and operate the node 510. Likewise, the computer 552 can access a website or portal to communicate with the node 510.

Wide area network 560 is shown sending and receiving data to a set of remote servers 562. In this manner, in embodiments, data, configurations, records, can be uploaded to the cloud servers for safe and back up storage 562. Particularly, the remote or cloud server can be programmed with instructions to host a node application for visualizing data of the node, communicating with the node, instructing the node, and to update firmware and software on node.

Node 510 is shown comprising a bus 514 or other communication mechanism for communicating information, and a hardware processor 516 coupled with the bus for processing information. Hardware processor may be, for example, a processing device as described herein.

The embodiment of the invention shown in FIG. 10 also includes a configuration and data storage memory 520, such as a flash or random-access memory (RAM) or other dynamic storage device, coupled to the bus 514 for storing information and instructions to be executed by processor 516.

The embodiment of the invention shown in FIG. 10 also includes a read only memory (ROM) 518 or other static storage device coupled to bus for storing static information and instructions for the processing device.

Collectively, the processor and memory are operable to communicate and instruct the sensors, controller, and status indicator.

The node 510 shown in FIG. 10 also includes a touch interface 522. As such, the operator may communicate directly with the node. For example, the user may have received a notification from the application on their mobile phone, or having seen the notification of a failed connected device from the status light. Upon inspection of the node, and connected devices, the user may then touch the device enclosure, or the touch sensor, to disable any ongoing alerts. Or through any pre-programmed directives, could touch with a pattern such as three times, to turn on a connected equipment, such as a pump.

The embodiment of the invention shown in FIG. 10 also includes a user interface 524 outside the node. In embodiments, a portable handheld dedicated device can communicate with the node. Such a device may include alphanumeric and other keys and can be wireless coupled to the bus for communicating information and command selections to processor via Bluetooth, infrared, or perhaps near field techniques.

The user interface may also be implemented on a tablet or smart phone, or computer connected to the node via the LAN or WAN or otherwise, as described above.

Additionally, in embodiments, a user interface can be incorporated into the node itself. An example of an onboard user interface is a small touchscreen display (note shown).

In embodiments of the invention, a system consists of one or more distributed monitoring nodes, field devices, sensors, mobile devices, fixed infrastructure devices, gateways, local computing resources, cloud servers, and user interface applications. Examples of field devices include, without limitation, irrigation controllers, pumps, valves, vehicles, tractors, implements, weather stations, environmental sensors, water level sensors, flow meters, pressure sensors, equipment monitors, livestock monitoring devices, utility infrastructure, or other remotely monitored devices as well as gateways, edge devices, communication devices, computing devices, and other similar equipment. In some embodiments, a monitoring node can be a field device. Accordingly, some types of field devices may contain a microcontroller, processor, memory, communications module, location determination hardware, status indicators, and one or more sensor interfaces. Communications may occur through cellular, Wi-Fi, Bluetooth, LoRa, mesh radio, satellite, Ethernet, serial communications, or combinations thereof.

Software may reside on multiple layers of the system, including firmware executing on field nodes, gateway software executing on local servers or edge devices, cloud-hosted server software, web-based software portals, desktop applications, and mobile applications. The software allows devices to collect, process, analyze, store, transmit, receive, visualize, and act upon field data. Field devices may communicate directly with cloud infrastructure or through one or more intermediate gateways. In certain embodiments, local servers or edge gateways may continue collecting and processing data even when cloud connectivity is unavailable, synchronizing information once communications are restored. Indeed, the states of field devices may be represented through multiple interfaces, including local status indicators, dashboards, maps, widgets, reports, APIs, workflows, mobile applications, or other computing systems.

In certain embodiments, the disclosed architecture may be implemented as a distributed platform in which multiple field devices, computing systems, gateways, cloud services, edge computing devices, mobile devices, and user interfaces cooperate to acquire, exchange, process, store, analyze, communicate, control, and present information. Processing may occur locally, remotely, or in a distributed manner across multiple computing resources, and the various embodiments described herein may be implemented independently or in any suitable combination.

### Location Computation

In embodiments, with reference to FIG. 11, a graphical user interface 600 displays a geographic representation of monitored devices 610 overlaid on satellite imagery 620, aerial imagery, terrain maps, custom maps, field boundaries, infrastructure layers, utility networks, work zones, geofences, or other geographic visualizations. Icons displayed on the map may represent specific device types such as sensors, pumps, valves, irrigation systems, tractors, vehicles, gateways 630, weather stations, communication towers, livestock, personnel, inventory devices, utility infrastructure, or other monitored objects. In certain embodiments, the icon shape (e.g., hexagon, circle, square, etc.), color (green, yellow, red, etc.), animation, size, orientation, brightness, pattern, border style, transparency, or other visual characteristics may indicate current operational status, health, activity level, alert conditions, communication quality, battery condition, maintenance state, operational mode, priority level, ownership, or user-defined classifications.

The illustrated antenna icon 630 represents a communications-enabled field device, gateway, relay station, vehicle-mounted monitoring unit, tractor-mounted unit, mobile device, or other wireless communications device. The icon may indicate the presence of wireless communications capabilities, network connectivity, signal strength, gateway status, routing functionality within a mesh network, or communications health.

The number “108.16” displayed adjacent to the icon 610 represents a dynamic data value associated with the device being monitored. Examples of types of data values being monitored include, without limitation, flow rate, pressure, soil moisture, battery level, water level, temperature, equipment speed, engine operating parameter, communication metric, calculated score, alarm count, productivity value, efficiency measurement, utilization value, user-defined variable, or other measured or calculated parameter. The displayed value may be updated in real time or near real time as new sensor data is received.

Location information may be determined using GPS, GNSS, RTK positioning, cellular triangulation, Wi-Fi positioning, Bluetooth beacons, dead reckoning, operator-entered coordinates, survey measurements, equipment telemetry, mapping tools, geofencing systems, image recognition systems, machine vision systems, drone imagery, satellite imagery analysis, or combinations thereof. Devices may report their own location directly or may have locations assigned through software configuration tools. Mobile devices such as tractors, vehicles, implements, livestock, personnel, and portable equipment may continuously update their positions while moving throughout a worksite.

The system may provide logic that improves speed, efficiency, reliability, and usability of the monitoring process. Examples include prioritizing transmission of alarm conditions over routine measurements, adaptive reporting intervals based on operational status, event-driven data collection, predictive communications scheduling, intelligent caching of map layers, geospatial clustering of devices, edge processing at field devices, compression of transmitted data, dynamic mesh routing, prioritization of critical infrastructure, automated suppression of redundant data transmissions, predictive fault detection, and automated identification of devices requiring immediate user attention. The system may automatically determine which devices require immediate user action and visually emphasize those devices within the graphical interface.

### Site-Based Data Management and Historical Continuity

In certain embodiments, the system implements a location-centric data architecture referred to as a “Site.” A Site (e.g., Site 640) represents a physical location, operational area, device grouping, field, facility, property, infrastructure component, project area, work zone, or geographic region that exists independently of any individual sensor or monitoring device. Unlike conventional monitoring systems that permanently associate collected data with a specific device, the disclosed system associates data with a Site, thereby allowing historical records to persist even when devices are replaced, relocated, upgraded, removed, reassigned, or supplemented with additional sensors.

A Site may contain one or more data sources, devices, sensors, gateways, vehicles, equipment devices, communication nodes, software-generated data streams, third-party integrations, or manually entered information. Multiple devices may contribute data to a single Site simultaneously, and a single device may contribute data to multiple Sites. As equipment is moved throughout a property, the system may automatically or manually associate collected measurements with one or more Sites based upon geographic location, user-defined assignments, geofencing rules, operational schedules, device relationships, workflow definitions, organizational hierarchy, or other association criteria.

The Site functions as a persistent digital representation of a real-world location, preserving historical continuity across years of operation regardless of changes in underlying hardware. Historical measurements, calculated metrics, recommendations, reports, alerts, events, annotations, photographs, maintenance records, operational records, user-generated content, and machine-generated insights may remain associated with the Site even when the original monitoring device is no longer present.

The graphical user interface 600 may compute sites 640 as distinct objects separate from devices. Site icons may utilize unique visual representations, colors, shapes, labels, symbols, status indicators, or custom iconography that distinguish Sites from underlying data sources. Users may interact directly with a Site to view aggregated measurements, historical trends, analytics, recommendations, alarms, reports, maps, dashboards, workflows, and operational data derived from multiple sensors and devices over time.

The system may generate Site-level analytics by combining information from multiple devices, sensor types, external data sources, and historical periods. Examples include field productivity assessments, irrigation performance evaluations, environmental condition summaries, infrastructure health monitoring, device utilization analysis, maintenance planning, operational efficiency scoring, sustainability metrics, resource consumption analysis, and predictive recommendations. Site-level calculations may continue uninterrupted even when contributing devices are replaced, removed, reassigned, or reconfigured.

The Site architecture enables long-term digital preservation of operational history and allows monitoring systems to evolve without fragmenting historical datasets, thereby improving data continuity, operational insight, reporting accuracy, predictive modeling, and long-term device management.

Users may remotely configure and program field devices through the graphical interface. Configuration settings may include measurement intervals, reporting intervals, communication parameters, alarm thresholds, operating schedules, device modes, geofencing rules, visual status rules, icon appearance, icon type, displayed measurements, color schemes, LED status indicators, blinking patterns, flash sequences, brightness levels, notification preferences, relay control rules, automation logic, and user access permissions. Configuration changes may be transmitted from the cloud platform through one or more communications networks to the target device, as described herein, where updated settings are stored within device memory and executed by the device processor.

In certain embodiments, the system may control visual indicators integrated into field devices, including multi-color LEDs, illuminated status bars, segmented indicators, light rings, displays, electronic labels, audible indicators, or combinations thereof. Users may remotely define what operational conditions correspond to specific colors, patterns, animations, intensities, flash rates, or visual effects. Example states may include OK, Ready, Active, Irrigating, In Use, Maintenance Required, Fault, Offline, Warning, Emergency, Low Battery, Low Water, Communication Failure, or user-defined states.

The system may perform advanced analysis of collected data. Raw measurements may be processed into derived values, health scores, risk scores, performance indices, maintenance recommendations, efficiency metrics, operational forecasts, anomaly detections, predictive maintenance alerts, irrigation recommendations, equipment utilization scores, water management recommendations, crop health indicators, livestock management recommendations, and other decision-support outputs.

In some embodiments, artificial intelligence, machine learning models, neural networks, statistical models, expert systems, digital twins, predictive analytics engines, trained inference models, reinforcement learning systems, or combinations thereof may be applied to historical and real-time data to generate recommendations, diagnoses, classifications, forecasts, alerts, automated workflows, and autonomous control actions. Such systems may continuously improve recommendations based upon historical outcomes, environmental conditions, equipment performance, operator actions, and measured results.

Models can be implemented both in the cloud and/or locally (e.g., on the ESP32-class processors using TinyML). In embodiments, the models evaluate heterogeneous field measurements, historical Site data, and operational history to identify abnormal sensor behavior, detect equipment faults, identify field conditions, generate recommendations, and, where appropriate, produce notification outputs or recommended actions. It is to be understood that the types of models may vary. Examples of models include Bayesian regression, time-series statistical analysis, and trained machine-learning models.

Examples include predicting irrigation requirements based upon weather forecasts and soil moisture trends, identifying abnormal equipment behavior before failure occurs, recommending maintenance schedules, detecting leaks, identifying inefficient operations, optimizing resource allocation, forecasting production outcomes, classifying field conditions, prioritizing service events, and generating operational recommendations for users.

The graphical user interface may permit users to select devices, search for devices, filter devices, view historical trends, access real-time measurements, configure alerts, review recommendations, acknowledge alarms, initiate remote control actions, assign devices to groups, define geofences, create automation rules, generate reports, modify icon appearance, assign custom labels, create Sites, assign devices to Sites, view Site analytics, compare devices, review historical events, and navigate between map, list, dashboard, reporting, workflow, configuration, and administration views.

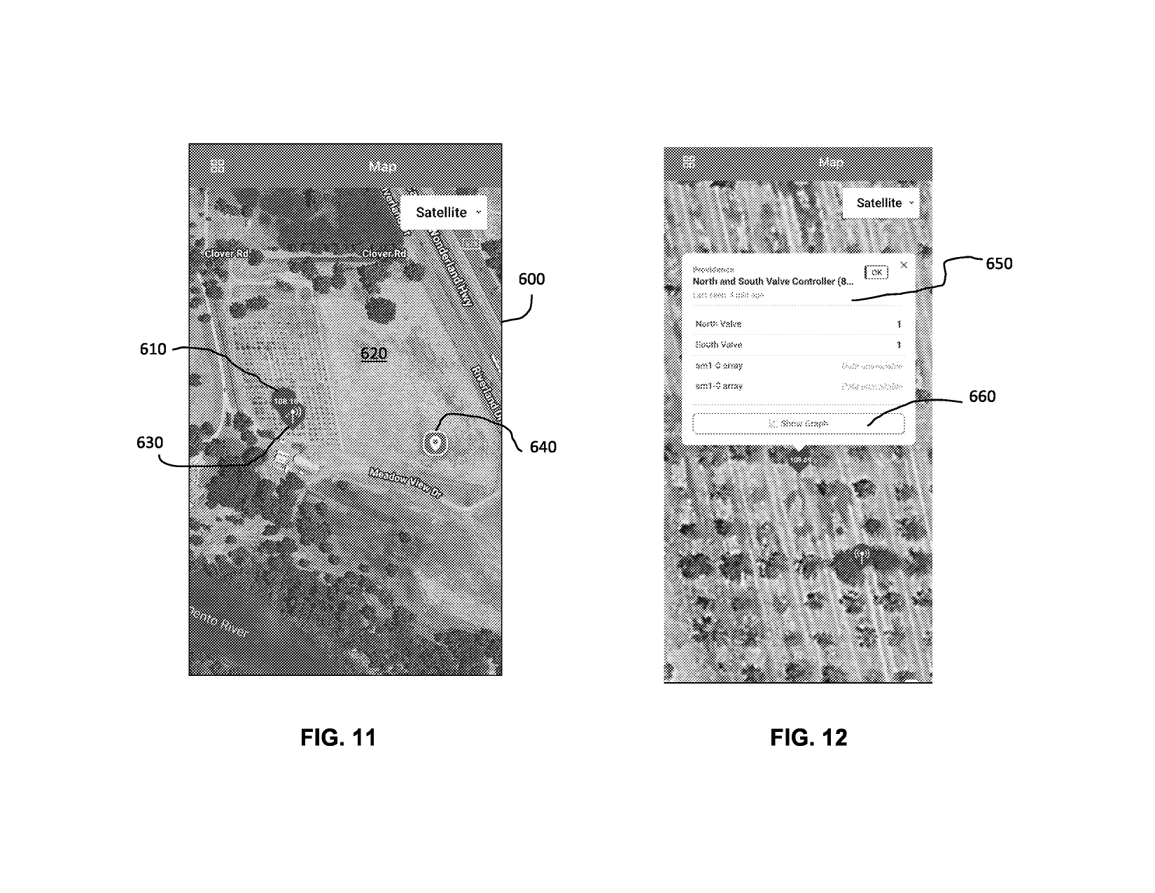

For example, with reference to FIG. 12, the GUI is operable to provide a pop-out 650 indicating the site name (e.g., Providence), the device names (e.g., North and South Valve Controller), the quantities (e.g., 1, 1), the values (109.69), with an option for the user to generate a historical graph of the values by selecting the graph tab 660.

The disclosed system may operate across agricultural, industrial, municipal, environmental monitoring, construction, utility, transportation, logistics, livestock, infrastructure management, energy management, manufacturing, smart city, public works, emergency response, and natural resource management applications.

### Square Form Factor

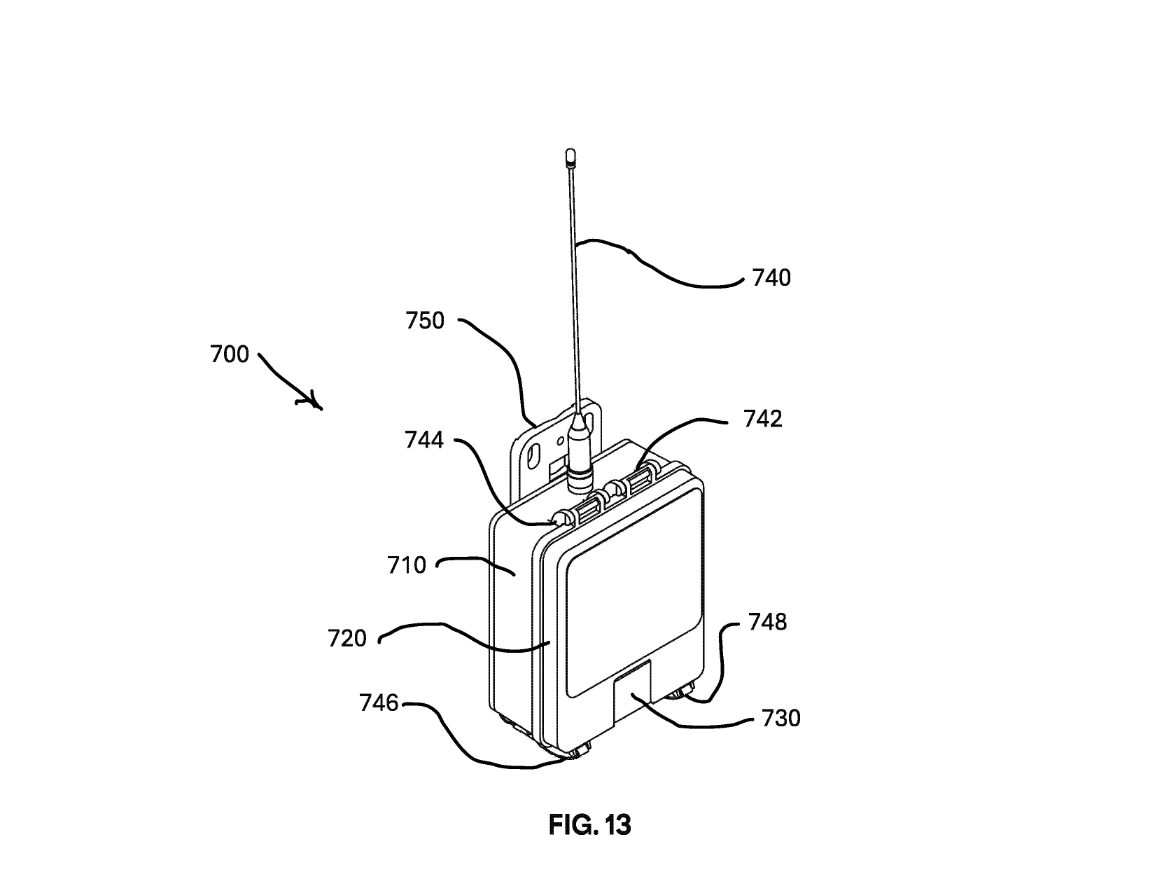

As discussed herein, the shape of the node may vary widely. In embodiments, for example, the node has a non-cylindrical shape. In embodiments, and with reference to FIG. 13, a node 700 has a substantially square form factor. The node 700 is shown including a square shaped enclosure 710, a cap 720, a light status indicator 730, an antenna 740. As described above, the enclosure 710 contains the electronics and power supply. Optionally, a base member 750 is coupled to the enclosure for conveniently mounting the node to a supporting structure through fastener holes. The base member also can comprise ports for managing electronic and communication cabling if desired.

In embodiments, the cap 720 of the node is removable from the enclosure 710, and in a preferred embodiment, the cap is rotatably coupled to the body of the enclosure 720 via hinge members 742, 744. Locking tabs 746, 748 are shown extending from the body of the enclosure 710 and operable to engage recesses in the cover 720 to secure the cover to the enclosure.

Light indicator 730 is shown arranged on the enclosure and, in particular, arranged generally in the center of a lower portion of cap 720. In the illustrated embodiment, light indicator 730 has a generally square visible area measuring approximately 2 inches by 2 inches. In other embodiments, the light indicator may have a circular, rectangular, polygonal, annular, linear, or other suitable shape and may be positioned at any suitable location on the enclosure.

In embodiments, light indicator 730 comprises one or more electrically controllable light-emitting elements. The light-emitting elements may comprise one or more light-emitting diodes (LEDs), multicolor LEDs, red-green-blue (RGB) LEDs, red-green-blue-white (RGBW) LEDs, individually addressable LEDs, LED pixels, LED arrays, light guides, or combinations thereof. The light indicator may include a transparent or translucent window, lens, diffuser, light pipe, encapsulant, or other optical structure through which light produced by the light-emitting element is visible.

In one implementation, light indicator 730 includes a digitally addressable RGB LED pixel operated from an approximately 5-volt electrical supply. The pixel includes, or is operatively coupled to, a multichannel LED driver configured to independently control red, green, and blue light-emitting channels. The driver may be a WS2811-compatible driver or another serially controlled, pulse-width-modulated, constant-current, or addressable lighting controller. The light-emitting element and associated driver circuitry may be at least partially encapsulated in epoxy, resin, silicone, polymer, or another protective material to provide environmental, mechanical, moisture, or electrical protection.

Each color channel may be controlled over a plurality of intensity levels. In embodiments employing 8-bit control for each of three-color channels, the light indicator may produce up to approximately 16.7 million nominal color combinations. The controller may adjust the color, brightness, duration, duty cycle, transition rate, flashing frequency, or illumination pattern of light indicator 730. The indicated brightness may range from an off state to a maximum output level of the selected light-emitting element and may be reduced through software or pulse-width modulation to conserve electrical power or accommodate ambient lighting conditions.

Light indicator 730 may be updated in response to data or instructions generated locally by the monitoring device (e.g., monitoring node 700), received from a remotely located computing system, or both. Updates may occur continuously, periodically, in response to an event, or upon a change in an operating condition. The light indicator may display a substantially steady color, a flashing color, a pulsing or breathing pattern, alternating colors, a sequence of colors, a variable-intensity pattern, or another visually perceptible indication.

The displayed color or illumination pattern may represent, without limitation, a device operating state, sensor status, sensor measurement, measurement range, threshold condition, alarm condition, warning condition, communication status, network connectivity, power condition, battery condition, charging condition, configuration state, maintenance condition, control-output state, or a combination thereof. For example, different colors may represent normal, cautionary, alarm, offline, or maintenance states. A flashing or pulsing pattern may indicate a changed condition, an unacknowledged alarm, an active communication process, or another state requiring attention.

The light indicator may represent the condition of the monitoring device (e.g., monitoring node 700) itself, one or more sensors connected to or associated with the monitoring device, one or more remotely located sensors or devices, an aggregation of measurements from multiple devices, or a condition determined by a local or remote computing system. Accordingly, the state displayed by light indicator 730 need not be based solely on a sensor physically housed within or directly connected to the enclosure.

In some embodiments, the light indicator is visible from multiple viewing angles and at a distance sufficient to permit an operator to determine an indicated status without physically accessing a user interface of the monitoring device. The optical output, viewing angle, diffusion, intensity, dimensions, and visibility distance may be selected according to the intended installation environment. No particular luminous-flux or lumen output is required, and the light output may vary according to the selected light-emitting element, optical covering, programmed intensity, supply voltage, and operating conditions.

Although a digitally addressable RGB indicator is described, other embodiments may use independently driven LEDs, non-addressable LEDs, segmented displays, illuminated symbols, electroluminescent elements, liquid-crystal displays, organic light-emitting diode displays, or other visual indicators capable of communicating the status of the monitoring system or a monitored condition.

In embodiments, the functionality and programmability of the electronics, power supply, logic arrays, and light status indicator is similar to the nodes (e.g., monitoring node 200, 510) described above.

However, and without intending to be bound to theory, a square-like form factor can provide advantages in manufacturability, mounting flexibility, packaging efficiency, thermal distribution, visual identification, modular expansion, and field serviceability. The square geometry permits multiple mounting orientations while maintaining a consistent appearance and functional operation. The enclosure may be mounted in horizontal, vertical, angled, vehicle-mounted, pole-mounted, wall-mounted, panel-mounted, equipment-mounted, trailer-mounted, or free-standing configurations.

Additionally, a square form factor enables standardized placement of sensors, antennas, solar charging components, batteries, processors, status indicators, communications hardware, connectors, expansion modules, mounting features, and sealing structures. The geometry facilitates efficient use of enclosure volume while reducing unused internal space and simplifying manufacturing and assembly operations.

In certain embodiments, the square architecture supports modular stacking, interchangeable accessory modules, expansion interfaces, removable covers, integrated solar panels, lighting systems, communication modules, interchangeable sensor assemblies, swappable batteries, and field-upgradable electronics. The form factor may permit multiple devices to be arranged in organized arrays or grouped installations while maintaining consistent visual appearance and installation practices.

The square shape additionally improves field visibility and provides a distinctive visual appearance that allows operators to readily identify the device from a distance while maintaining compatibility with a wide variety of installation environments. The shape may further provide increased surface area for displays, labels, branding, solar collection, status indicators, and user interaction elements compared to elongated or irregular enclosure geometries.

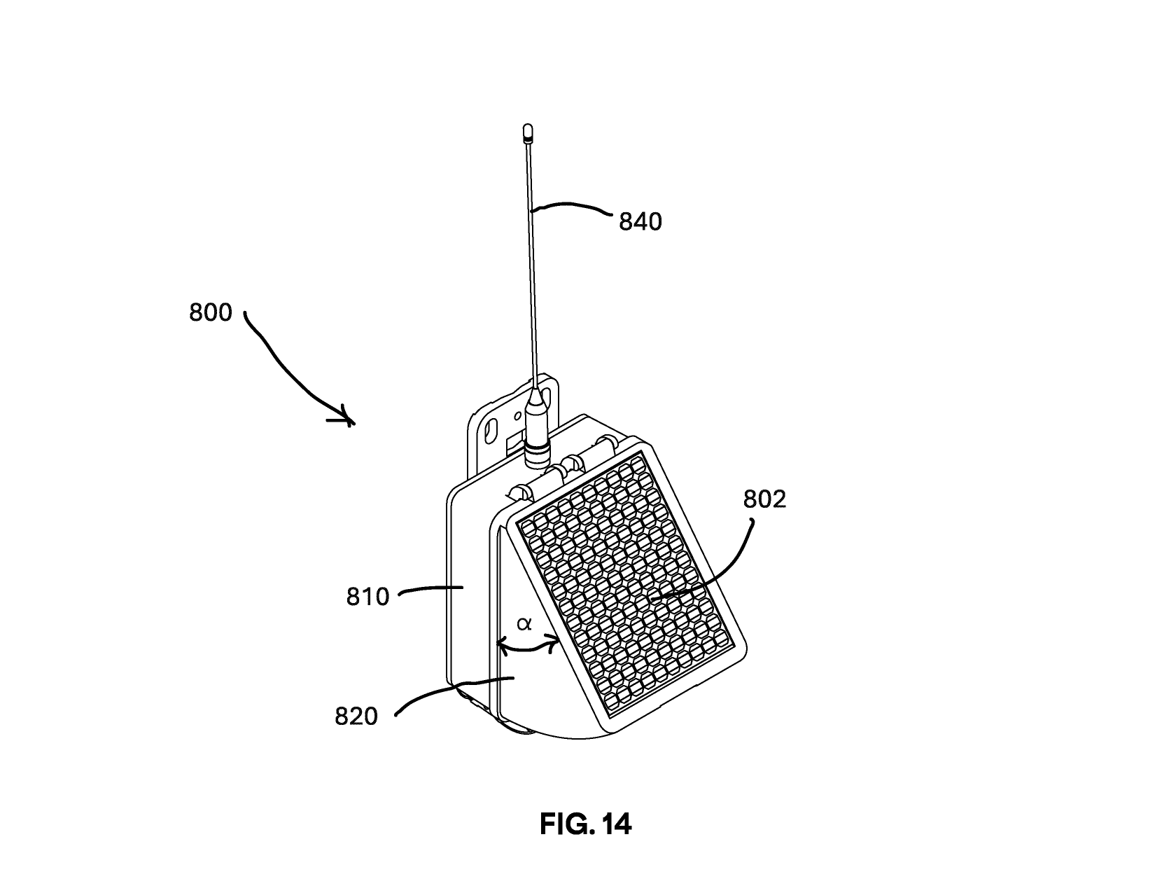

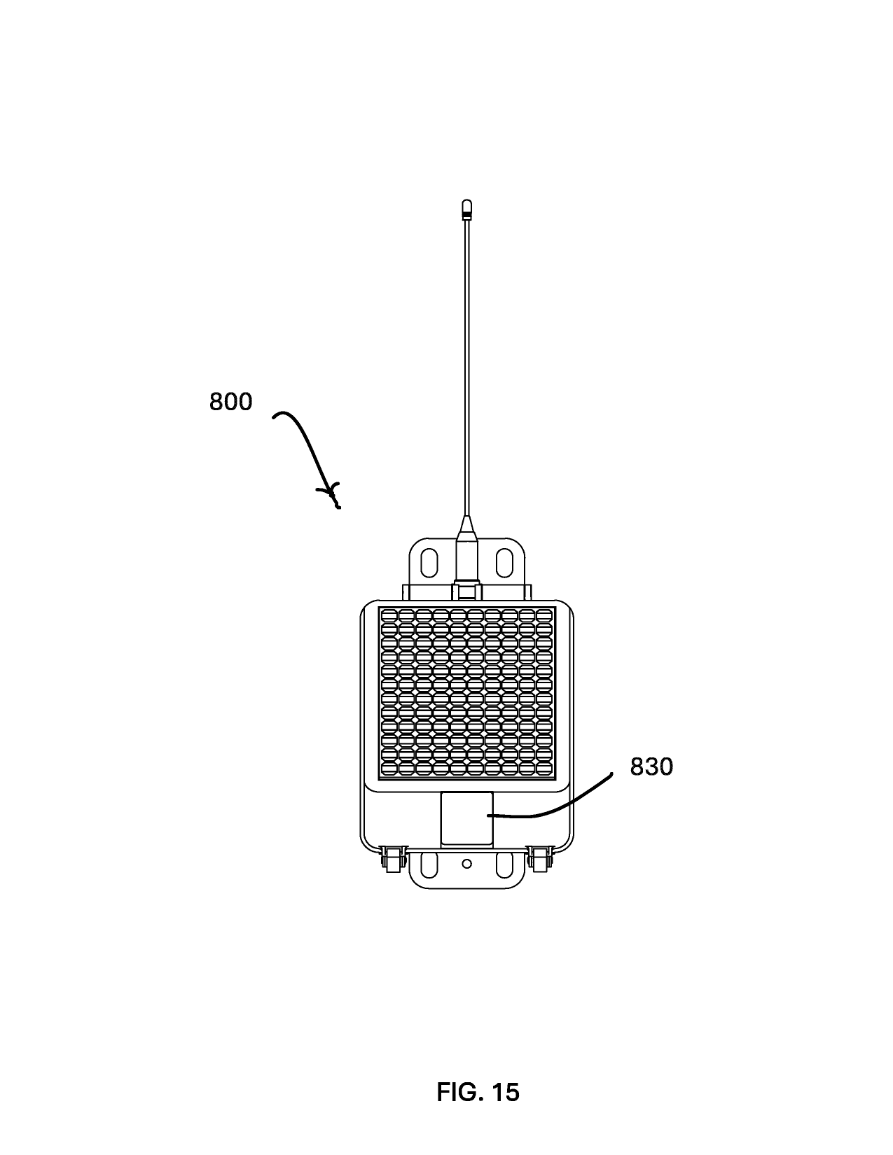

With reference to FIGS. 14-15, a node 800 is shown including an enclosure 810, cap 820, light indicator 830, antenna 840, and an external solar energy source 802. As shown, the solar energy source 802 is arranged at an angle (α) to the enclosure. In embodiments, angle (α) ranges from 30-60 degrees from a vertical plan, and preferably from 40-50 degrees. In embodiments, the solar energy source 802 has a planar shape comprising an array of solar elements. An example of a solar array is JY D145X145, manufactured by Guangdong Jinyuan Solar Energy Co., Ltd. (China). Rated voltage:6V; Rated power:3W; Size:145x145mm/5.71"x5.71"(L*W).

In embodiments, the solar energy source 802 is electrically connected through the cap 820 to an internal rechargeable battery in order to provide consistent power to the internal electronics and status light indicator 830. In embodiments, the functionality and programmability of the electronics, power supply, logic arrays, and light status indicator is similar to the nodes described above.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the embodiments described herein and other functions. For example, a tangible medium such as a hardware storage device can be used to store the control logic, which can include executable instructions.

Other modifications and variations can be made to the disclosed embodiments without departing from the subject invention.

We claim:

1. A field-deployed monitoring system for sensing operating conditions of at least one device on a site and providing a visible indication without requiring a display, the system comprising:
a monitoring node comprising:
an enclosure;
a processor and memory disposed within the enclosure;
a wireless communication module;
one or more sensor interfaces configured to receive signals representing operating conditions of the at least one device; and
an exteriorly arranged status indicator comprising at least one light source;
wherein the processor is configured to:
compare the received signals to stored status indication logic including one or more conditions associated with the at least one device;
activate the status indicator to provide different light patterns, intensity, or color based on a condition of the at least one device so as to provide a visible indication of the condition; and
wherein the monitoring node is operable to receive and store updated status indication logic to define the light patterns, intensity, or color associated with the condition of the at least one device whereby the light patterns, intensity, or color are configurable.

2. The system of claim 1, further comprising a solar energy source arranged on the enclosure.

3. The system of claim 1, further comprising a computing device, said computing device comprising a graphical user interface configured to configure the status indicator by mapping a sensor condition to a corresponding light indicator action.

4. The system of claim 3, wherein the graphical interface is configured to present representations of a plurality of monitoring nodes in relation to a physical environment and to indicate a condition of each monitoring node via the representations.

5. The system of claim 4, wherein the graphical interface is further configured to present information corresponding to operating conditions of the monitoring nodes, selectively present a subset of the information based on one or more criteria, and generate an export of the information.

6. The system of claim 3, wherein the computing device is located on the site.

7. The system of claim 1, further comprising a computing device configured to maintain a representation of a site associated with a plurality of monitoring nodes, wherein the representation of the site is retained independent of changes to the plurality of monitoring nodes such that information corresponding to operating conditions at the site is preserved when at least one monitoring node is removed or replaced.

8. A non-transitory computer-readable medium storing instructions that, when executed by a processor of a monitoring node, cause the monitoring node to:
receive signals representing operating conditions of at least one device;
compare the received signals to stored status indication logic including one or more conditions associated with the at least one device, the stored status indication logic including one or more threshold values associated with operating conditions of the at least one device; and
activate a status indicator exteriorly arranged on the monitoring node to provide different light patterns, intensity, or color based on a condition of the at least one device.

9. The computer-readable medium of claim 8, wherein the instructions further cause the monitoring node to: receive and store updated status indication logic that defines the light patterns, intensity, or color associated with the condition of the at least one device whereby the light patterns, intensity, and color are configurable.

10. The computer-readable medium of claim 8, wherein the instructions further cause a computing device associated with the monitoring node to provide a graphical interface configured to define a correspondence between a sensor condition and a light indicator action of the status indicator.

11. An automated monitoring node for indicating status of one or more sensors comprises:
a main circuit board;
an enclosure housing the main circuit board;
a radio communication and central processing unit module supported by the main circuit board and operable with an antenna to provide wireless connectivity; and an exteriorly arranged status indicator, the status indicator comprising at least one light source operable to emit a plurality of different user-chosen light patterns, intensities and color; and wherein the radio communication and central processing unit module is operable to:
receive, from a remote server, instructions for monitoring the sensors, wherein the instructions include user-chosen status indicator actions and a mapping of sensor inputs and outputs, and conditions to corresponding user-chosen status indicator actions;
store the instructions in a local storage on the node,
check the local storage for updates to instructions and update the local storage according to the instructions if an update was received by the node; and
check the local storage for a matching sensor input and output, and instruct the status indicator to perform a status indicator action according to the local storage; and
wherein the status indicator action comprises a user-chosen light pattern, intensity, and color for each condition for each sensor.

12. The node as recited in claim 11, wherein the radio communication and central processing unit module is multi-functional and operable to communicate using different types of wireless platforms comprising Wi-Fi, Bluetooth, Cellular, Satellite, and/or RF.

13. The node as recited in claim 12, wherein sensor data is communicated via the radio communication and central processing unit module is operable to either a cloud-based application server, or an on-premise server, or to any node connected to the same network and or server.

14. The node as recited in claim 11, wherein node is operable to be programmatically controlled, in-field using a configuration interface through mobile phone, or computer, or remotely using a cloud connected application.

15. The node as recited in claim 11, wherein, when the node is powered up, it checks internal storage of the device, for pre-programmed status indication logic to retrieve the instructions/arrays of stored logic.

16. The node as recited in claim 11, wherein the local storage comprises a first logic array, whereby if a sensor is below a value threshold, the light color will be red, bright intensity, and flashing.

17. The node as recited in claim 11, wherein, when the node has completed normal setup and is operating, the status of the inputs and outputs are periodically compared against the logic rules stored in the local storage to determine if any condition matches and if a condition is matched, the corresponding action will be activated, and optionally, a message is generated to display the corresponding message in a cloud connected application.

18. The node as recited in claim 11, wherein the node is operable to allow a user to re-program the operation of the status indicator using either a directly connected computer using the programming port, remote wireless interface, or the cloud connected application from a mobile device or desktop application.

19. The node as recited in claim 11, further comprising an external solar energy source for charging the battery.

20. The node as recited in claim 11, wherein the computing device is a mobile computing device.
